(19) United States
(12) Patent Application Publication
(10) Pub. No.: US 2015/0068055 A1
(43) Pub. Date: Mar. 12, 2015

(54) VERTICAL PLASTIC MATERIAL DRYING APPARATUS

(71) Applicant: BAN-CHIH WANG, TAICHUNG CITY (TW)

(72) Inventor: BAN-CHIH WANG, TAICHUNG CITY (TW)

(21) Appl. No.: 14/023,513

(22) Filed: Sep. 11, 2013

(51) Int. Cl. B29B 13/06; F26B 17/12

(52) U.S. Cl. CPC B29B 13/065; F26B 17/128
USPC 34/88; 34/92

(57) ABSTRACT

A vertical plastic material drying apparatus having an initial dryer, a vacuum drying hopper and a storage hopper, which form a vertical combination. The storage hopper is connected to a molding machine. A control valve is disposed between neighboring two of the initial dryer, the vacuum drying hopper and the storage hopper and controls the falling amount of the granular or powdery plastic material. In addition, a hot air steam device is connected to the initial dryer and provides the high-temperature hot air to enter the initial dryer. A vacuuming device is connected to the vacuum drying hopper and vacuums the gas from the vacuum drying hopper. Because the initial dryer, the vacuum drying hopper and the storage hopper are combined into the vertical form and cannot be moved, the ground area occupied by the drying apparatus is smaller so that the optimization spatial availability is obtained.

### BACKGROUND OF THE INVENTION

1. Field of the Invention

The invention relates to the technical field of a plastic material drying apparatus, and more particularly to a vertical plastic material drying apparatus.

2. Related Art

For a processing apparatus of injection molding, a granular or powdery plastic material needs to be in a dried state so that a product with a good quality can be manufactured.

A conventional drying apparatus includes a material hopper, a heater and a blower. When the granular or powdery plastic material is placed in the material hopper, the heater can heat the air and the blower inputs the heated air to the material hopper, so that the moisture in the granular or powdery plastic material and the moisture in the hopper are evaporated by the high-temperature air.

However, the drying and outputting of the granular or powdery plastic material are finished in the same hopper. Thus, the next filling, heating-drying and discharge procedures cannot be performed after the granular or powdery material in the material hopper is completely outputted. Based on the above-mentioned condition, the drying procedure of the granular or powdery plastic material needs a longer period of time, thereby decreasing the processing efficiency of injection molding significantly.

U.S. Pat. No. 6,154,980 discloses a drying system with a plurality of hoppers. The positions of the hoppers in this patent can be changed cyclically, and different positions of each hopper correspond to different drying procedures. For example, when the hopper is at the filling and heating position, the filling and heating processes are performed to evaporate the moisture; when the hopper is at the vacuum and drying position, the hopper is vacuumed to discharge the moisture; and when the hopper is at the discharge position, the granular or powdery material in the hopper is discharged.

Although the '980 patent provides the circulating drying procedures, the most time-consuming procedure is the heating procedure. In general, the heating temperature needs to be 170° C., and the heating time ranges from 25 to 30 minutes. Thus, after a hopper is placed at the filling and heating position for 30 minutes, it can be moved to the vacuum and drying position, where the drying procedure can be finished in one or two minutes.

However, the heating procedure of the hopper at the filling and heating position has not been finished yet. So, 28 minutes have to be waited before the positions of the hoppers can be changed. The hopper needs about one hour from filling to discharging the granular or powdery plastic material, and then the granular or powdery plastic material cannot be further discharged until 30 minutes have elapsed. For the overall processing procedures, the heating-drying procedure of the '980 patent is time-consuming. In addition, the hoppers are rotated to change the positions thereof on the same horizontal plane, so the larger space has to be used.

### SUMMARY OF THE INVENTION

An object of the invention is to provide a vertical plastic material drying apparatus having the smaller volume and thus having the effect of optimizing the spatial availability.

To achieve the above-mentioned object and effect, the invention discloses a vertical plastic material drying apparatus having an initial dryer, a vacuum drying hopper and a storage hopper, which form a vertical combination. The storage hopper is connected to a molding machine. A control valve is disposed between neighboring two of the initial dryer, the vacuum drying hopper and the storage hopper and controls the falling amount of the granular or powdery plastic material. In addition, a hot air steam device is connected to the initial dryer and controls the high-temperature hot air to enter the initial dryer. A vacuuming device is connected to the vacuum drying hopper and vacuums the gas from the vacuum drying hopper.

Because the initial dryer, the vacuum drying hopper and the storage hopper are combined into the vertical form and cannot be moved, the ground area occupied by the drying apparatus is smaller.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematic illustration showing a structure and an arrangement of the invention.

FIG. 2 is a schematic illustration showing another structure and another arrangement of the invention.

### DETAILED DESCRIPTION OF THE INVENTION

The present invention will be apparent from the following detailed description, which proceeds with reference to the accompanying drawings, wherein the same references relate to the same elements.

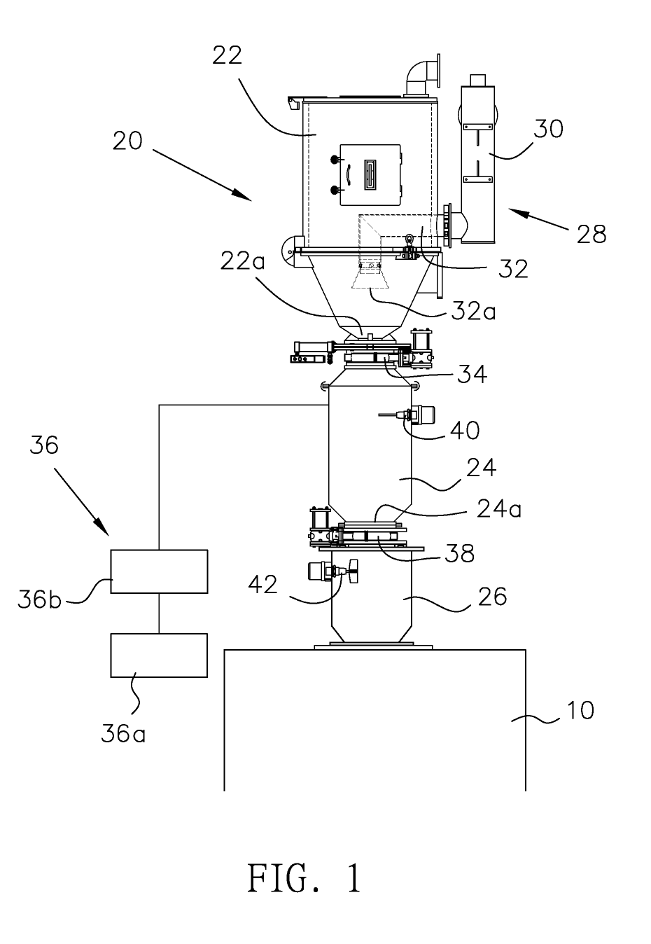

Referring to FIG. 1, a vertical drying apparatus (20) is disposed on a molding machine (10). The drying apparatus (20) includes an initial dryer (22), a vacuum drying hopper (24) and a storage hopper (26), all of which are sequentially arranged from top to bottom in a vertical manner.

A hot air steam device (28) is connected to the initial dryer (22). Furthermore, the hot air steam device (28) includes a combination of a heater (30) and an air duct (32). The air duct (32) has one end disposed inside the initial dryer (22), and the other end connected to the heater (30).

The heater (30) is disposed outside the initial dryer (22), and can receive and heat the external air. For example, a blower can be utilized to blow the air into the heater (30), in which the air is heated to rise the temperature of the air. The heated hot air can be inputted to the initial dryer (22) through the air duct (32).

The initial dryer (22) has one end formed with an initial discharge port (22a) corresponding to the vacuum drying hopper (24). A first control valve (34) is adapted to the initial discharge port (22a), so that the open time of the first control valve (34) can control the amount of the granular or powdery plastic material falling from the initial dryer (22) to the vacuum drying hopper (24).

In addition, the first control valve (34) may also be adapted to the top of the vacuum drying hopper (24) to control the falling timing and amount of the granular or powdery plastic material from the initial dryer (22).

A vacuuming device (36) is connected to the vacuum drying hopper (24). The vacuuming device (36) includes a combination of a vacuum generator (36a) and a solenoid (36b). The vacuuming device (36) is for vacuuming the gas from the vacuum drying hopper (24).

One end of the vacuum drying hopper (24) is formed with a vacuum discharge port (24a) corresponding to the storage hopper (26). A second control valve (38) is adapted to the vacuum discharge port (24a). The open time of the second control valve (38) can control the amount of the granular or powdery plastic material falling from the vacuum drying hopper (24) to the storage hopper (26).

\In addition, the second control valve (38) may also be adapted to the top of the storage hopper (26) to control the falling timing and amount of the granular or powdery plastic material from the vacuum drying hopper (24).

\In order to control the falling amount of the granular or powdery plastic material more precisely, a first sensor (40) is mounted inside the vacuum drying hopper (24). A second sensor (42) is mounted inside the storage hopper (26).

When the invention is used, a lot of granular or powdery plastic materials are placed into the initial dryer (22), and the outlet (32a) of the air duct (32) approaches the initial discharge port (22a). Thus, the granular or powdery plastic material around the initial discharge port (22a) can obtain the best drying effect.

When the first control valve (34) opens, the granular or powdery plastic material around the initial discharge port (22a) can fall into the vacuum drying hopper (24) with the first priority. Thereafter, the first control valve (34) closes, and only a little granular or powdery plastic material is left in the vacuum drying hopper (24).

Enabling the vacuuming device (36) can discharge the gas from the vacuum drying hopper (24). Because the gas pressure inside the vacuum drying hopper (24) decreases, the boiling point of the water inside the hopper decreases. Thus, the moisture mixed with the gas or the granular or powdery plastic material becomes the water vapor, which is discharged upon vacuuming, so that the granular or powdery plastic material can achieve the real drying effect.

When the second control valve (38) opens, the dried granular or powdery plastic material falls into the storage hopper (26) and is to be used as required.

The drying procedure of the initial dryer (22) of the invention is continuously performed. After the vacuum drying hopper (24) finishes the vacuum drying procedure, the granular or powdery plastic material inside the initial dryer (22) can immediately fall into the vacuum drying hopper (24) so that another drying procedure can be performed. Therefore, the invention has the effect of decreasing the drying procedure, and can shorten the drying time of the granular or powdery plastic material supplied to the molding machine (10) each time.

The initial dryer (22), the vacuum drying hopper (24) and the storage hopper (26) are sequentially arranged from top to bottom to form a vertical form, so that the usage of the transversal (horizontal) space thereof is smaller and the invention can be adapted to the place with the smaller area.

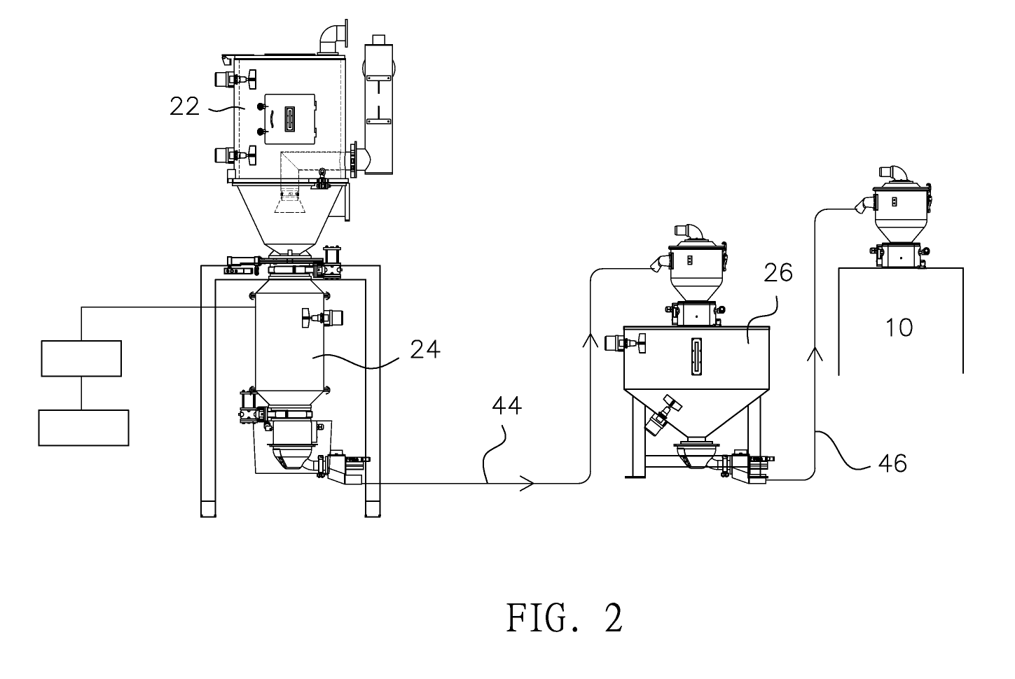

As shown in FIG. 2, another embodiment of the invention has the initial dryer (22) and the vacuum drying hopper (24) sequentially arranged to form the vertical form. However, a first feeding tube (44) connects the vacuum drying hopper (24) to the storage hopper (26). The storage hopper (26) abuts the molding machine (10) and is connected to the molding machine (10) through a second feeding tube (46). Thus, the combination of the initial dryer (22) and the vacuum drying hopper (24) still can achieve the effect of occupying the smaller ground area.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A vertical plastic material drying apparatus, comprising:
an initial dryer having one end formed with an initial discharge port;
a hot air steam device, which is connected to the initial dryer and provides high-temperature hot air into the initial dryer;
a first control valve adapted to the initial discharge port of the initial dryer;
a vacuum drying hopper having one end formed with a drying discharge port and the other end connected to the first control valve, wherein the vacuum drying hopper and the initial dryer are combined into a vertical form;
a vacuuming device, which is connected to the vacuum drying hopper and for vacuuming gas from the vacuum drying hopper; and
a second control valve adapted to the drying discharge port of the vacuum drying hopper.

2. The drying apparatus according to claim 1, further comprising a storage hopper, which is connected to the second control valve, wherein the vacuum drying hopper, the initial dryer and the storage hopper are combined into a vertical form.

3. The drying apparatus according to claim 1, further comprising a storage hopper and a first feeding tube, wherein the storage hopper abuts a combination of the vacuum drying hopper and the initial dryer, and the first feeding tube connects the vacuum drying hopper to the storage hopper.

4. The drying apparatus according to claim 1, wherein the hot air steam device comprises a heater and an air duct, and the air duct has one end disposed inside the initial dryer and the other end connected to the heater and disposed outside the initial dryer.

5. The drying apparatus according to claim 1, wherein the vacuuming device comprises a combination of a vacuum generator and a solenoid.

6. The drying apparatus according to claim 1, further comprising a first sensor, which is mounted inside the vacuum drying hopper and for detecting an amount of a granular or powdery plastic material.

7. The drying apparatus according to claim 2, further comprising a second sensor, which is mounted inside the storage hopper and for detecting an amount of a granular or powdery plastic material.

8. The drying apparatus according to claim 3, further comprising a second sensor, which is mounted inside the storage hopper and for detecting an amount of a granular or powdery plastic material.
